(19) United States
(12) Patent Application Publication
(10) Pub. No.: US 2016/0117402 A1
(43) Pub. Date: Apr. 28, 2016

(54) SYSTEMS AND METHODS FOR INTEGRATING PERSONAL SOCIAL NETWORKS WITHIN AN ORGANIZATION

(71) Applicant: Rockefeller Consulting Technology Integration, Inc. d/b/a RockTech, Cambridge, MA (US)

(72) Inventor: David M. Gowel, Arlington, MA (US)

(73) Assignee: Rockefeller Consulting Technology Integration, Inc. d/b/a RockTech, Cambridge, MA (US)

(21) Appl. No.: 14/926,479

(22) Filed: Oct. 29, 2015

Related U.S. Application Data
(63) Continuation of application No. 13/992,403, filed on Aug. 19, 2013, now abandoned.
(60) Provisional application No. 61/421,827, filed on Dec. 10, 2010.

(51) Int. Cl. G06F 17/30

(52) U.S. Cl. CPC G06F 17/30867; G06F 17/30528; G06F 17/30477

(57) ABSTRACT

A method includes receiving, from a user device, a first signal, the first signal including an authorization indicator associated with a social network system profile of a first user. A second signal is sent, the second signal including a first request for social network information associated with the first user. The first request is based at least in part on the authorization indicator. A third signal is received, the third signal including social network information associated with the first user. The method further includes receiving, from a second user, a fourth signal, the fourth signal including a second request for social network information associated with the first user. One or more metrics is defined, based at least in part on the social network information associated with the first user. A fifth signal is sent, the fifth signal sent such that a visual element based at least in part on the one or more metrics is displayed at an output device.

### CROSS-REFERENCE TO RELATED APPLICATIONS

This application claims benefit of priority to U.S. Provisional Application Ser. No. 61/421,827, entitled “Systems and Methods for Integrating Personal Social Networks Within an Organization,” filed Dec. 10, 2010, which is incorporated herein by reference in its entirety.

### BACKGROUND

Embodiments described herein relate generally to social network integration, and more particularly to systems and methods for integration of one or more personal social networks into a unified organizational and/or corporate model.

Organizations, such as businesses, generally consist of a variety of members (e.g., employees) operating with distinct roles and within a specified personnel hierarchy. Through both its members and designated departments (e.g., sales or marketing), such organizations often seek exposure and external collaboration opportunities (such as business relationships, partnerships, donor relationships, etc.) by leveraging the personal and professional contacts of each member. This process can be frustrated, however, by inefficiencies often inherent in obtaining information about the real-world social networks of the organization's members. While some known systems can aggregate outside contact information directly entered therein by each member of the organization, the process of entering data into such systems is often tedious and considered a distraction from daily work tasks, resulting in a paucity of member contributions—and thus an incomplete and relatively unhelpful store of data. Further, such known systems often fail to adequately produce webs of connections that can exist between multiple outside contacts and multiple organization members, and/or to identify areas of strength and weakness within an organization's collective, outward-facing social network. Finally, known systems often fail to provide useful metrics that allow executives, a marketing department, or other relevant decision-makers to assess areas of particular need, locate potential client procurement opportunities and/or identify organization members with outside relationships crucial to a given internal goal or program.

As social network systems have grown in prominence and utility over recent years, a large percentage of the general population (including members of such organizations) has defined a profile and formed a personal social network on one or more social-networking systems and/or websites, such as LinkedIn, Facebook, Twitter and the like. These personal social networks generally include a number of contacts outside the member's organization, such as current and former professional and/or personal contacts. In many instances, an individual's personal social network is well-developed and includes a sizeable number of weak, moderate and strong connections across a broad range of industries, disciplines and/or geographic locations. Accordingly, these varied connections often contain a wealth of information describing the nature and depth of an individual's connections outside of his or her organization.

Because in the aggregate the above-described information is extensive in both contact number and depth, an organization could theoretically utilize such personal social network information to facilitate its outward-facing collaboration efforts. Thus, a need exists for systems and methods that integrate the personal social networks of an organization's members into a unified organization-level social network information system. A need further exists for systems and methods to allow the derivation of useful statistics and analysis based on the real-world connections included in the personal and unified social networks.

### SUMMARY

In some embodiments, a non-transitory processor-readable medium can store code representing instructions configured to cause a processor to receive, from a user device, a first signal, the first signal including an authorization indicator associated with a social network system profile of a first user. The code can further represent instructions configured to cause the processor to send a second signal, the second signal including a first request for social network information associated with the first user, the first request being based at least in part on the authorization indicator. The code can further represent instructions configured to cause the processor to receive a third signal, the third signal including social network information associated with the first user. The code can further represent instructions configured to cause the processor to receive, from a second user, a fourth signal, the fourth signal including a second request for social network information associated with the first user. The code can further represent instructions configured to cause the processor to define, in response to the fourth signal, one or more metrics based at least in part on the social network information associated with the first user. The code can further represent instructions configured to cause the processor to send a fifth signal, the fifth signal sent such that a visual element based at least in part on the one or more metrics is displayed at an output device.

### BRIEF DESCRIPTION OF THE DRAWINGS

FIG. 1 is a schematic block diagram of a social network system integration system, according to an embodiment.

FIG. 2 is a schematic block diagram of an organization server, according to an embodiment.

FIG. 3 is a schematic block diagram of an organization server configured to define a unified social network information system associated with an organization and provide analytics thereon, according to an embodiment.

FIG. 4 is a flow chart illustrating a method of defining a unified social network information system for an organization based on one or more personal social networks, and outputting, at a display, one or more metrics based thereon, according to an embodiment.

FIG. 5 illustrates a real-world social network, according to an embodiment.

FIGS. 6-13 illustrate user-interface screens associated with an implementation of a social network integration system, according to various embodiments.

### DETAILED DESCRIPTION

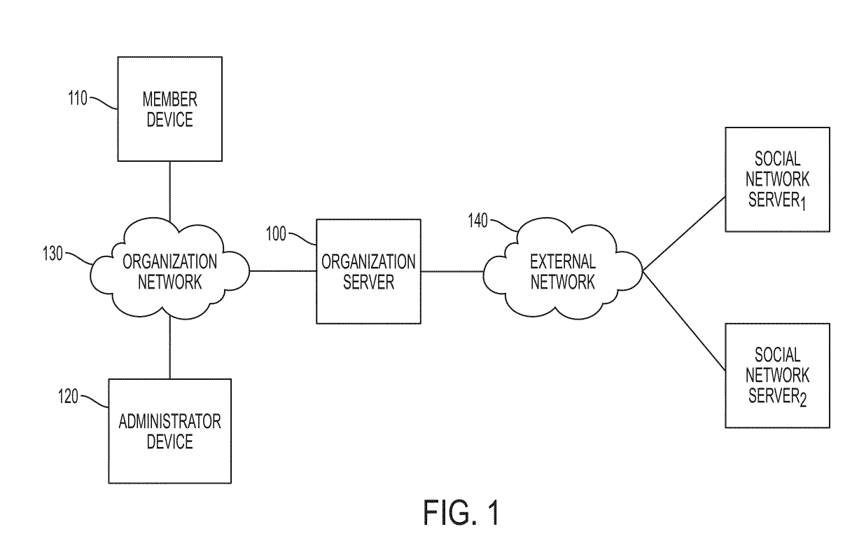

FIG. 1 is a schematic block diagram of a social network integration system, according to an embodiment. More specifically, FIG. 1 illustrates an organization server 100 operatively coupled to an organization network 130 and an external network 140. The organization server 100 is operatively coupled to a member device 110 and an administrator device 120 via the organization network 130. Although shown as including one member device 110 and one administrator device 120, in other embodiments, a social network integration system can include any number of member devices and/or administrator devices. The organization 100 is also operatively coupled to a first Social network system server1 and to a second Social network system server2 via the external network 140.

The organization server 100 can be any combination of hardware and/or software configured to exchange information with each of the member device 110, the administrator device 120, the first Social network system server1 and the second Social network system server2. For example, the organization server 100 can be a computing device, such as a rack server, tower server, mainframe, or other computing device configured to exchange information via a wired and/or wireless network, such as an Ethernet and/or Fibre Channel network. In some embodiments, the organization server 100 can include one or more Network Interface Cards (NICs) and/or one or more Host Bus Adapters (HBAs) configured to exchange data frames and/or packets via the organization network 130 and/or the external network 140. Although not shown in FIG. 1, in some embodiments the organization server 100 can be operatively coupled to one or more external memories, such as one or more databases. In such embodiments, the one or more external memories can be physically coupled to the organization server 100 (and thus disposed at substantially the same location as the organization server 100) or operatively coupled to the organization server 100 via a network (such as the organization network 130).

In some embodiments, the organization server 100 can include a web server hardware and/or software (executing in hardware) module configured to serve web content to one or more devices, such as, for example, the member device 110 and/or the administrator device 120 (via the organization network 130). The organization server 100 can also be configured to send one or more requests to the Social network system server1 and or the Social network system server2 via the external network 140. In such embodiments, the organization server 100 can be configured to receive, in response to the one or more requests, social network information associated with one or more members of an organization.

The member device 110 and the administrator device 120 can each be any combination of hardware and/or software (executing in hardware) configured to enable interaction with the organization server 100 via the organization network 130. For example, member device 110 and the administrator device 120 can each be a client computing device, such as a personal computer or mobile device. More specifically, the member device 110 and the administrator device 120 can each be a laptop, tablet, desktop, or other personal computing device, or, alternatively, a smartphone, personal digital assistant (PDA), or other mobile computing device. The member device 110 and the administrator device 120 can each optionally include one or more hardware and/or software modules configured to connect (i.e., operatively couple) the member device 110 to one or more other devices via one or more networks. For example, member device 110 and/or the administrator device 120 can include one or more NICs and or HBAs configured to enable connectivity via an Ethernet or Fibre Channel network, respectively.

In some embodiments, the member device 110 can further include one or more hardware and/or software (executing in hardware) modules configured to allow a user of the member device to authorize access to a social networking profile (e.g., a social networking profile associated with that user). In some embodiments, the administrator device 120 can further include one or more hardware and/or software (executing in hardware) modules configured to allow a user of the administrator device 120 to request and/or receive an authorization indicator from a member of an organization. The authorization indicator can indicate and/or grant permission allowing the user of the administrator device 120 to request information associated with a social network of the member of the organization via the organization server 100. In some embodiments, the administrator device can include one or more hardware and/or software modules (executing in hardware) configured to receive social network information associated with one or more members of the organization, and/or aggregated metrics, charts, graphics, etc. based on the social network information.

The organization network 130 can be any computer network configured to relay information between multiple computing devices. As shown in FIG. 1, the organization network 130 is operatively coupled to each of the member device 110, the administrator device 120 and the organization server 100. In some embodiments, the organization network can be a local area network (LAN) and/or wide area network (WAN) associated with an organization, such as a business, non-profit organization, and the like.

The external network 140 can be any computer network configured to relay information between multiple computing devices, such as the organization server 100, the Social network system server1 and the Social network system server2. For example, the external network 140 can be a public and/or private network, such as the Internet.

The Social network system server1 and the Social network system server2 can each be any combination of hardware and/or software (executing in hardware) configured to receive, store and/or transmit information associated with a social network system. For example, the Social network system server1 and/or the Social network system server2 can include information associated with one or more users of a social network system, such as user profile information, user contact, friend and/or network information, user message information, etc. Either or both of the Social network system server1 and the Social network system server2 can further include hardware and/or software modules configured to transmit the above-described information in response to one or more Application Programming Interface (API) requests received from, for example, the organization server 100 (via the external network 140). In some embodiments, the Social network system server1 and the Social network system server2 can be associated with the same and/or different social network systems.

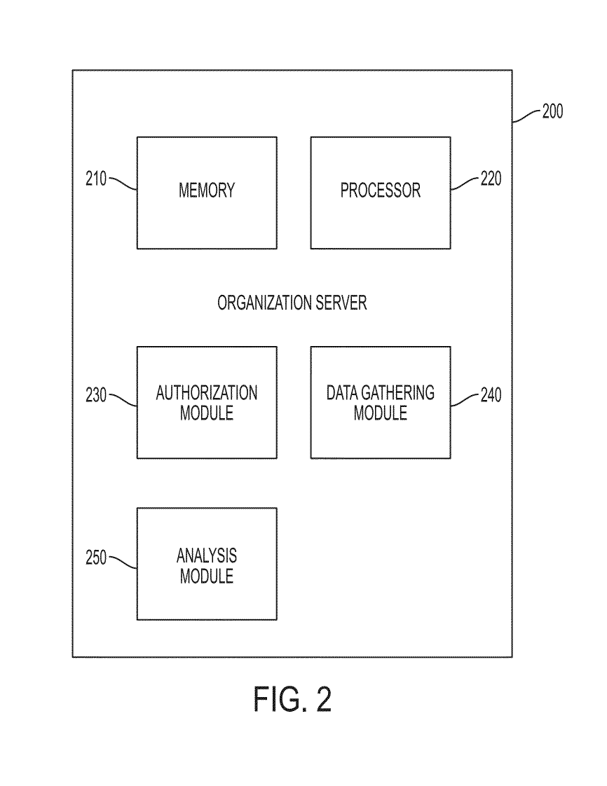

FIG. 2 is a schematic diagram of an organization server, according to an embodiment. More specifically, FIG. 2 illustrates an organization server 200 that includes a memory 210, a processor 220, an authorization module 230, a data-gathering module 240, and an analysis module 250. The organization server 200 can operate in a similar manner as the organization server 100 shown and described above.

The organization server 200 can be, for example, any server computing and/or communication device, such as a rack server, a desktop server, a tower-based server, a mainframe, etc capable of providing social network integration functionality to one or more users. For example, the organization server 200 can be a social network integration server operatively coupled to one or more social network system servers (e.g., the social network system servers 150 and 160 described in FIG. 1 above) and to one or more organization-specific devices (e.g., the member device 110 and the administrator device 120 described in FIG. 1 above). As described herein, the organization server 200 can be configured to receive, from the one or more social network system servers, social network information associated with one or more members of the organization, and provide, to the one or more organization-specific devices, data, metrics, graphics, etc. based on the received social network information.

The memory 210 can be any suitable computer memory. For example, the memory can be random-access memory (RAM), read-only memory (ROM), flash memory, erasable programmable read-only memory (EPROM), electrically erasable programmable read-only memory (EEPROM), and/or other suitable memory. In some embodiments, the memory 210 can be configured to store code representing processor instructions for execution by the processor 220 and/or store data received from any of the input device 230, the output device 240, the authorization module 250, the data-gathering module 260 and/or the analysis module 270.

The processor 220 can be any suitable processor capable of executing computer instructions. In some embodiments, the processor 220 can be a microcontroller, a field-programmable gate array (FPGA), an application specific integrated circuit (ASIC), and/or any other suitable processor.

The authorization module 230 can be a hardware-based and/or software-based module (executing in hardware) configured to request and/or receive authorization from a member of an organization and/or a member device to obtain social network information associated with that member. For example, in some embodiments, the authorization module 230 can send (e.g., to a member device), via an organization network (e.g., the organization network 130 described in FIG. 1 above), one or more signals including one or more requests to access social network information associated with one or more members of the organization. The requests can be included in, for example, one or more electronic mail (e-mail), website-based invitation, or other messages sent via the organization network.

The data-gathering module 240 can be any suitable combination of hardware and/or software configured to request and receive social network information associated with one or more members of an organization. For example, in some embodiments, the data-gathering module 240 can include a software layer configured to utilize an application programming interface (API) that enables the data-gathering module 240 to send, to a social network system server, one or more requests for social network and/or profile information associated with an organization member. The organization member can have, for example, an account with one or more social network systems, each of which stores information at its respective social network system server. In some embodiments, the one or more requests can include authentication information to authenticate the organization member account at the one or more social network system servers. The authentication information can include information based at least in part on and/or derived at least in part from a response to an authorization request (described above). In some embodiments, the data-gathering module 240 can store the received social network information at a memory, such as the memory 210 and/or an internal and/or external storage medium, such as a removable media disk, drive and/or database (not shown in FIG. 2). In some embodiments, the one or more requests can include one or more requests to update one or more fields of data associated with the member's social network profile, such as status, profile picture, location, professional and/or other social network information associated with the social network system account of the organization member.

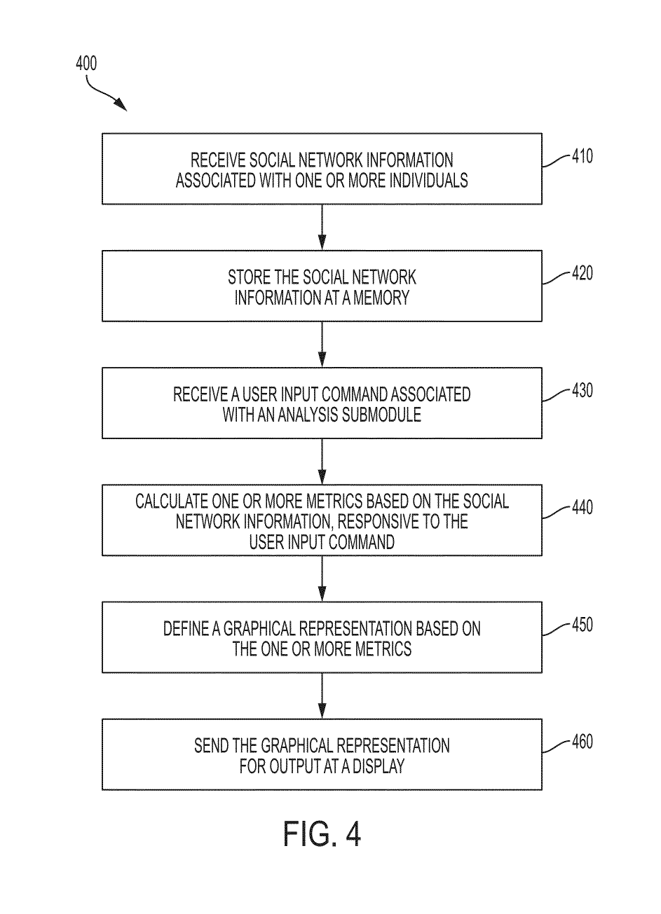

The analysis module 250 can be any suitable combination of hardware and/or software configured to perform one or more calculations and/or other analyses on social network information received and/or stored by the data-gathering module 240. For example, the analysis module 250 can calculate and provide one or more metrics, reports and/or statistics based on received social network information associated with one or more organization members. More specifically, the analysis module 250 can calculate a report detailing a total number of external (i.e., outside the organization) contacts associated with all organization members, a total number of external contacts associated with a specified subset of organization members, a number of external contacts within a specified industry associated with all organization members, etc. More detail associated with these metrics, reports and/or statistics is included in connection with FIG. 4 below.

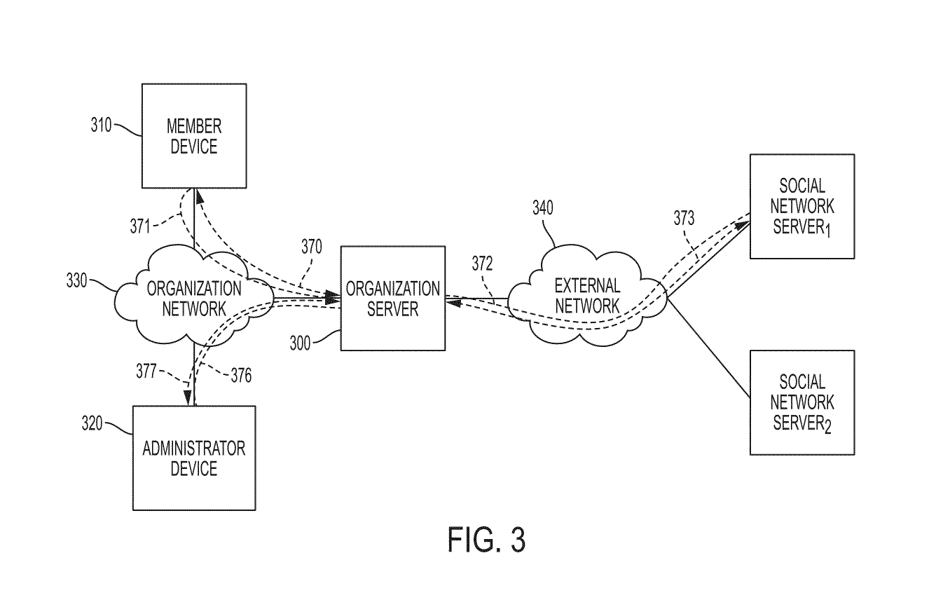

FIG. 3 is a schematic block diagram of an organization server configured to define a unified social network information system associated with an organization and provide analytics thereon, according to an embodiment. More specifically, FIG. 3 illustrates an organization server 300 operatively coupled to an organization network 330 and an external network 340. The organization 300 is operatively coupled to a member device 310 and an administrator device 320 via the organization network 330. The organization 300 is also operatively coupled to a first Social network system server1 and to a Second social network system server2 via the external network 340.

The organization server 300 can be any combination of hardware and/or software configured to: (1) receive organization member authorization, (2) obtain social network information associated with one or more organization members (and/or from one or more social network systems), thereby defining a unified organization social network system associated with the organization and (3) provide analytics associated with the unified social network information system in response to one or more requests. In some embodiments, the organization server 300 can be a computer server, such as a rack server, and can be substantially similar to the organization server 100 discussed in connection with FIG. 1 above. As shown in FIG. 3, the organization server 300 can be operatively coupled to and capable of exchanging information with each of the member device 310 and the administrator device 320 (via the organization network 330), and each of the Social network system server1 and the Social network system server2 (via the external network 340). Although discussed below as being a single server device, in some embodiments the functions and/or steps performed by the organization server 300 can optionally be performed by multiple server devices associated with the organization. For example, the functions could be performed by a set of co-located and/or distributed server devices, the server devices being owned, leased and/or rented by the organization.

The member device 310 can be any combination of hardware and/or software (executing in hardware) configured to allow a member of an organization to interact with the organization server 300 via the organization network 330. For example, the member device 310 can be a personal computer, smartphone or other mobile device, tablet computer, or other device capable of exchanging information with the organization network 330. In some embodiments, the member device 310 can be substantially similar to the member device 110 discussed in connection with FIG. 1 above. In some embodiments, the member device 310 can further include one or more hardware and/or software (executing in hardware) modules configured to allow a user of the member device (i.e., a member of an organization) to authorize access to a social networking profile associated with that user/member.

The administrator device 320 can each be any combination of hardware and/or software (executing in hardware) configured to allow an administrator of an organization to exchange information with the organization server 300 via the organization network 330. For example, the administrator device 320 can be a client computing device, such as a personal computer or mobile device. More specifically, the administrator device 320 can be a laptop, tablet, desktop, or other personal computing device, or, alternatively, a smartphone, personal digital assistant (PDA), or other mobile computing device. In some embodiments, the administrator device 320 can be substantially similar to the administrator device 120 discussed in connection with FIG. 1 above. In some embodiments, the administrator device 320 can further include one or more hardware and/or software (executing in hardware) modules configured to allow a user of the administrator device 320 to request and/or receive an authorization indicator from a member of an organization. The authorization indicator can indicate and/or grant permission allowing the user of the administrator device 320 to request information associated with a social network of the member of the organization via the organization server 300. In some embodiments, the administrator device can include one or more hardware and/or software modules (executing in hardware) configured to receive social network information associated with one or more members of the organization, and/or aggregated metrics, charts, graphics, etc. based on the social network information.

The organization network 330 can be any computer network configured to relay information between multiple computing devices. As shown in FIG. 3, the organization network 330 is operatively coupled to each of the member device 310, the administrator device 320 and the organization server 300. In some embodiments, the organization network can be a local area network (LAN) and/or wide area network (WAN) associated with an organization, such as a business, non-profit organization, and the like. The external network 340 can be any computer network configured to relay information between multiple computing devices, such as the organization server 300, the social network system server1 and the social network system server2. For example, the external network 340 can be a public and/or private network, such as the Internet. In some embodiments, each of the organization network 330 and the external network 340 can be substantially similar to the organization network 130 and the external network 140, respectively, discussed in connection with FIG. 1 above.

The Social network system server1 and the Social network system server2 can each be any combination of hardware and/or software (executing in hardware) configured to receive, store and/or transmit information associated with a social network. For example, the Social network system server1 and/or the Social network system server2 can include information associated with one or more users of a social network system, such as user profile information, user contact, friend and/or network information, user message information, etc. Either or both of the Social network system server1 and the Social network system server2 can further include hardware and/or software modules configured to transmit the above-described information in response to one or more Application Programming Interface (API) requests received from, for example, the organization server 300 (via the external network 340). In some embodiments, the Social network system server1 and the Social network system server2 can be associated with the same and/or different social network systems. In some embodiments, each of the Social network system server1 and the Social network system server2 can be substantially similar to the social network system servers, respectively, discussed in connection with FIG. 1 above.

As shown in FIG. 3, the organization server 300 can send a signal 370 to the member device 310, via the organization network 330. The signal 370 can include a request for authorization from a user of the member device 310 (i.e., a member of the organization) to request and/or receive (or allow the organization server 300 to request and/or receive) information associated with a social network system profile of that user/organization member. In some embodiments, the request for authorization can be included in an e-mail message, instant message, website posting or web page element, Really Simple Syndication (RSS) feed item, and/or other message type. In some embodiments, the request can alternatively be sent to the member device 310 by a social network system server, such as the Social network system server1 (via the external network 340 and the organization network 330).

Upon receiving the signal 370 including the request for authorization, the member device 310 can output text, graphics and/or an audible output associated with the request at a display of the member device 310 (not shown in FIG. 3). In response to the text, graphics and/or audible output, the user of the member device 310 can provide user input configured to send a signal 371 to the organization server 300 (via the organization network 330). The signal 371 can include a response to the request for authorization, the response indicating in the affirmative or the negative, i.e., the response granting or denying authorization for the organization server 300 to request and receive information associated with a social network system profile of the user of the member device 310 (i.e., organization member). In some embodiments, the response to the request for authorization can include additional, more granular authorization information. For example, the response can include one or more indications that the user has granted or denied access to various portions of his or her social network system profile, has granted or denied access to the authorized portions to one or more groups or individuals within the organization, and/or has granted or denied access to the authorized social network system profile information for a given period of time, etc. More specifically, the response can include an indication that the user/member has granted authorization to information associated with only a subset of his or her social network system contacts, has granted authorization to only specified types of information associated with the set or subset of social network system contacts, etc.

If the response included in the signal 371 indicates an affirmative response, the organization server 300 can send a signal 372 to the Social network system server1 (via the external network 340). In other embodiments, the organization server 300 can send one or more signals to the Social network system server2. The signal 372 can include a request for social network system profile information associated with a social network system account of the user of the member device 310 organization member. The request can be defined based at least in part on the specific type and/or scope of access granted by the user/member in the response described above. In some embodiments, the signal 372 can be formatted and/or defined according to one or more APIs associated with the social network system to which the social network system account (and the Social network system server1) pertains. In this manner, the signal 372 can be readable by the Social network system server1, inasmuch as it is formatted in a predefined manner specified by the social network system.

As shown in FIG. 3, the organization server 300 can next receive a signal 373 including a response to the request for social network system profile information associated with the social network system account of the user/member. The signal 373 can include the requested information, and in some embodiments can be formatted according to the one or more predefined APIs described above. In some embodiments, the signal 373 can be representative of one or more additional signals (not shown in FIG. 3), each of the one or more additional signals including information associated with the social network system profile and/or contacts of the user/member. In some embodiments, each of the one or more additional signals can be received at a first time, across various time periods and/or in accordance with a regular update schedule. In some embodiments one or more additional signals can be received from the Social network system server1 in response to a change to the social network system profile and/or contact information associated with the user/member.

Upon receipt of the social network system profile and contact information associated with the user/member, the organization server 300 can store the information for subsequent access and/or use. For example, the organization server 300 can store the information at a memory (such as the memory 210 discussed in connection with FIG. 2 above). Additionally or alternatively, the organization server 300 can store the social network information at an external memory, such as an external database or plurality of databases and/or disks operatively coupled to the organization server 300 (not shown in FIG. 3). Although not shown in FIG. 3, in some embodiments, the organization server 300 can perform the steps and/or process described above to obtain social network system profile and contact information associated with multiple members of the organization. In this manner, the organization server 300 can define a unified social network information system for the organization, the unified social network information system including social network system profile and contact information associated with multiple and/or a majority of members of the organization. This unified social network information system can thus include information associated with an aggregated set of contacts of the multiple members of the organization.

Having defined the unified social network information system for the organization, the organization server 300 can receive one or more requests to provide information associated with the unified social network information system. More specifically, the organization server 300 can receive multiple requests (e.g., web requests) from one or more client devices, via, for example, a web-based application based on the unified social network information system. As shown in FIG. 3, the organization server 300 receives (via the organization network 330), a signal 376 from the administrator device 320. The signal 376 can include, for example, a Hypertext Transfer Protocol (HTTP) request or other request for information associated with the unified social network information system. For example, the request can include a request for information associated with one or more contacts of a specified member of the organization. The request can optionally include a request for metadata indicating a total number of contacts of the specified member, a total number and/or list of contacts of the specified member that work in a particular industry, a total number and/or list of contacts that belong to a particular company or other organization. The request can optionally include a request for historic data indicating a value of each of the above data over a specified period of time, so as to determine, for example, an upward or downward trend. The request can also include a request for one or more ranking positions for the specified member, such as a ranking, relative to other members of the organization, of total external contacts within a given industry or other organization.

In some embodiments, the request can include a request for aggregate information based on the combined set of contacts of all and/or a subset of members of the organization for which social network system information has been obtained. For example, the request can include a request for a total number and/or list of contacts of all members of the organization who work in a specified industry and/or at a specified company or other organization. The request can also include a request for a total number and/or list of contacts of a certain type, such as contacts holding an employment position at a certain hierarchical and/or managerial level. The request can optionally include a request for historic data indicating a value of each of the above data over a specified period of time, so as to determine, for example, an upward or downward trend within the organization as a whole, and/or within a selected group or department within the organization. The request can also include a request for one or more ranking lists, such as a ranking list of members of the organization by total external contacts within a given geographic region.

In some embodiments, the request can include a request for text information, such as comments, “success stories”, questions and/or other text-based information associated with one or more outside organizations or companies. This text information can be generated and saved at the organization server 300 by, for example, one or more members of the organization. Although shown in FIG. 3 with respect to the administration device 320, in some embodiments the request can be sent by and/or received from one or more member devices, such as the member device 310. In such instances, the request sent from the member device can be based at least in part on one or more permissions granted to the requesting member/user of the member device by the organization server 300. In this manner, the organization server 300 can ensure that appropriate information is accessible to a given member or administrator based on his or her position and/or access rights. Additionally, in this manner a requesting member/user can request information associated with his or her own social network system profile and/or contacts, allowing that member/user to track his or her own progress toward predefined training, social-networking and/or business development goals.

Upon receipt of the signal 376 including the request, the organization server 300 can retrieve and/or calculate the requested information. When the requested information has been obtained and/or calculated, the organization server 300 can next send a signal 377 to the requesting device (i.e., the administrator device 320) via the organization network 330. The signal 377 can include a response that includes the requested information. The response can be, for example, an HTTP response including Hypertext Markup Language (HTML) and/or other data, such as text, graphic and/or multimedia data. In some embodiments, the response can be formatted such that a client module (such as a web browser) instantiated at the administrator device 320 can render the received information for consumption by a user of the administrator device 320. In this manner, the organization server 300 can provide information associated with the unified social network information system to one or more members and/or administrators of the organization, thereby informing marketing, goal-setting, client relations, employee evaluations, business development and/or other plans and efforts of the organization.

FIG. 4 is a flow chart illustrating a method of defining a unified and/or integrated social network associated with an organization based on one or more personal social networks, and outputting, at a display, one or more metrics based thereon, according to an embodiment.

As shown in FIG. 4, an organization social network module can receive social network information associated with one or more individuals in the organization, 410. The organization social network module can be any combination of hardware and/or software (executing in hardware) configured to obtain, with authorization, social network system profile and/or contact information associated with one or more members of an organization. In some embodiments, the organization social network module can be located and/or instantiated at a computing device and/or server (e.g., the organization server 300 discussed in connection with FIG. 3). The organization social network module can optionally receive the social network information from one or more devices (such as servers) and/or individuals associated with a social network system or website such as, for example, LinkedIn, Facebook, Friendster, Orkut, MySpace and the like. In some embodiments, the organization social network module can optionally receive the social network information in response to one or more requests sent to the one or more devices and/or individuals.

The organization social network module can store the received social network information at a memory, 420. More specifically, the organization social network module can store the received information at one or more internal and/or external memories, such as RAM, internal flash memory, hard disk drive, removable media (e.g., optical disk, flash memory drive, memory tape), etc. In some embodiments, the one or more of the internal and/or external memories can be co-located with the organization social network module and/or be physically located at a different location than the organization social network module. In some embodiments, any portion of the internal and/or external memories can be instantiated at one or more devices, the one or more devices being owned, leased, rented, licensed and/or otherwise under the control of the organization. The organization social network module can also store the received information in one or more formats, such as any combination of text files, database tables including multiple fields, etc. By aggregating the social network information into an aggregated set of data (stored at one or more memories and/or locations), the organization social network module can thus define a unified social network information system for the organization.

The organization social network module can receive a user input command associated with an analysis submodule, 430. More specifically, the organization social network module can include an analysis submodule or module, such as the analysis module 250 discussed in connection with FIG. 2 above. The analysis submodule can be any combination of hardware and/or software instantiated at, for example, a server. The analysis submodule can be configured to perform one or more calculations and/or derive one or more metrics based on the unified social network information system for the organization. For example, the analysis submodule can receive, from a device of a member of the organization (via the organization social network module), a request for social network information associated with that member. More specifically, the analysis submodule can receive a request for a total number and/or list of contacts within that member's personal social network. The analysis submodule can also optionally receive a request for detailed information associated with a selected one or multiple contacts within that member's personal social network. Additionally, the analysis submodule can receive, from the member, a request for metric/statistic and/or metadata associated with his or her social network. This metric/statistic and/or metadata can include, for example, historical data showing changes to the member's social network over time, such as total number of contacts, total number of contacts within a given or specified industry, total number of contacts at a particular company or organization, total number of contacts in a given region or geographic location, total number of contacts of a given type (i.e., at a given hierarchical position within their company or organization), or any combination of the above. The analysis submodule can also define a social network ranking for a member relative to other members of the organization. In yet another example, the analysis submodule can define a ranking for the member based on a comparison of the total number of contacts within a given industry (e.g., the fashion industry) included in each member's personal social network.

As discussed in FIG. 3 above, the analysis submodule can also receive one or more requests from one or more devices associated with one or more administrators of the organization. Any or each of these requests can include a request for information, such as the information specified above, based on the personal social network of a single member of the organization, a selected set or group of members of the organization and/or the organization as a whole.

Having received the request, the analysis submodule can calculate the requested one or more metrics based on the social network information, 440. In some embodiments, the analysis submodule can employ one or more calculation packages and/or submodules, such as those known in the art. Alternatively, the analysis submodule can employ one or more custom-defined algorithms, executed in hardware and/or software, the algorithms being associated with social network metrics. Although not described in FIG. 4, in some embodiments, the analysis submodule can also provide information associated with one or more training courses and/or tracks associated with a member of the organization. In such embodiments, the analysis submodule can send information associated with the member's progress within a given training course and/or indicate completion thereof.

Based on the calculated and/or derived metrics, the organization social network module can define one or more graphical representations, 450. More specifically, the organization social network module can define, in response to the request, one or more two- and/or three-dimensional line graph, pie chart, bar chart list, table and/or other graphical representations of the requested data. For example, the analysis submodule included in the organization social network module can define a line graph depicting a total number of personal social network contacts (included in all the social networks of members of the organization) within a given industry (such as the banking industry), over time. In another example, the analysis submodule can define a pie chart depicting the proportions of personal social network contacts associated with a set of industries (e.g., the printing, publishing, content management and journalism industries). In yet another example, the analysis submodule can define a ranking of members of the organization by total external contacts within a specified geographic region (e.g., the Northeastern United States).

Having defined the one or more graphical representations, the organization social network module can send information sufficient to render the one or more graphical representations at a display, 460. More specifically, the organization social network module can send the calculated metrics and/or the graphical representations based thereon to a member and/or administrator device for output at a display. For example, the organization social network module can send one or more signals, via an internal computer network, including one or more image files configured to display the graphical representations. The one or more image files can be in the Graphics Interchange Format (GIF), Joint Photographic Experts Group (JPEG), Portable Networks Graphic (PNG), Tagged Image File Format (TIFF) Microsoft Visio (VSD) or other format. Upon receipt at the member and/or administrator device, the graphical representations can be output at a display, allowing one or more users of the device(s) to determine the status of organization contacts in various industries, companies, managerial levels, and/or periods in time.

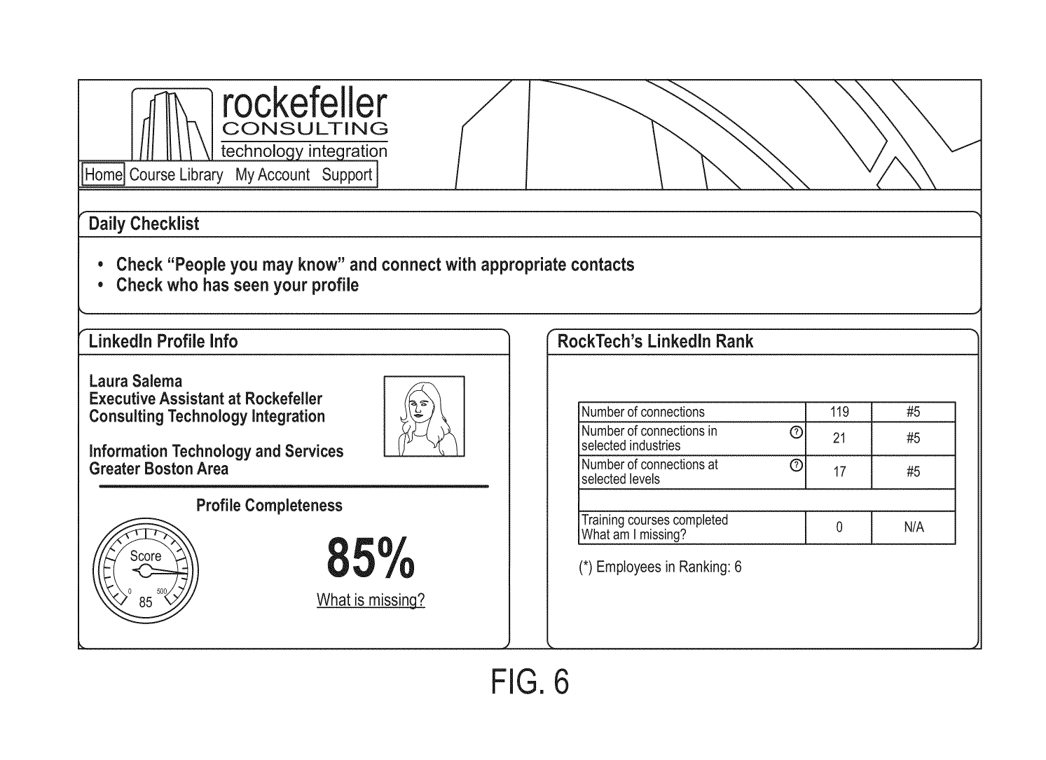

In some embodiments, the member and/or administrator device can present the user with a dashboard interface. The dashboard interface can, for example, present one or more options to a user, such as options for requesting and/or viewing the calculated information and/or graphical representations described above. More information associated with an example dashboard interface and/or graphical representations is included in FIGS. 6-14 described herein.

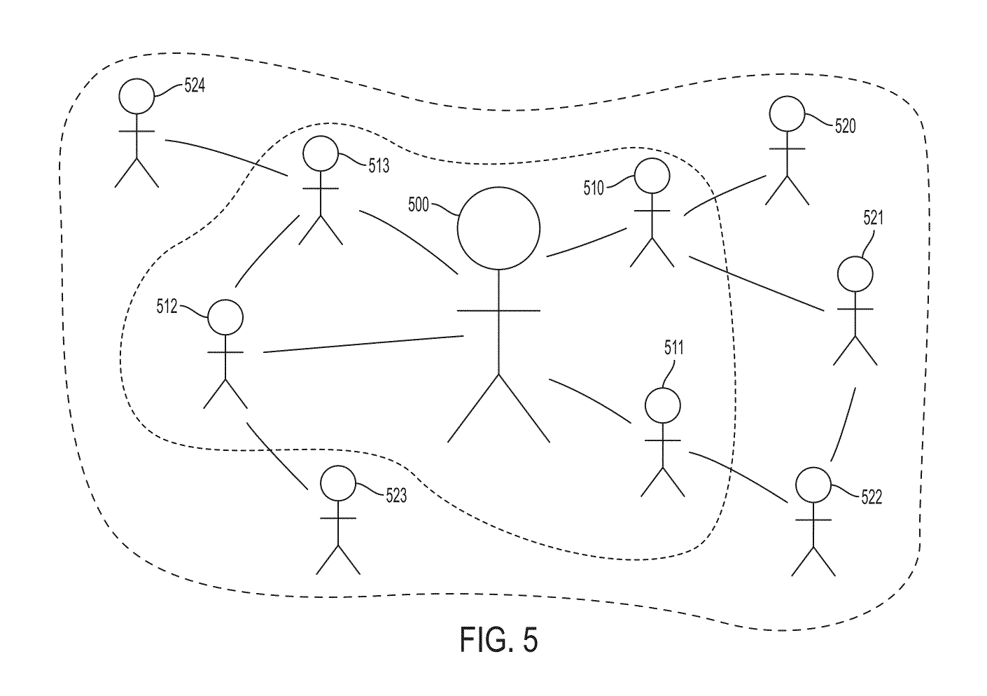

FIG. 5 illustrates a real-world social network, according to an embodiment. More specifically, FIG. 5 illustrates an individual 500 having a direct connection to each of individuals 510-513 and a second-degree connection to each of individuals 520-524. Said differently, FIG. 5 illustrates a first set of individuals directly known by and/or connected to the individual 500 (i.e., the individuals 510-513) and a second set of individuals connected to the individual 500 only through one or more of the individual's direct contacts (i.e., the individuals 520-524). Thus, FIG. 5 is a representation of a real-world social network, in which the individual 500 has a set of direct relationships and a larger set of indirect relationships, i.e., relationships based on a mutual acquaintance and/or relationships existing via one degree of separation.

As discussed in connection with FIGS. 1-4 above, a computer and/or web-based social network system, such as Facebook, LinkedIn, Orkut and the like, can include social network profile and/or contact information associated with an individual and the individual's real-world contacts. This social network profile and/or contact information can include name, location, professional, education, interest, and/or other information associated with the individual and his or her contacts. By accessing this social network information in the manner described herein, a system and/or module can determine one or more lists, statistics and/or metrics describing the individual and/or that individual's real-world relationships and contacts. Thus, by aggregating social network profiles and contact information associated with multiple individuals, such as multiple members of an organization, a system and/or module can determine the above-described lists, statistics and/or metrics for a given member of the organization, a subset of members of the organization and/or all members of the organization. By displaying this derived information in text-based and/or graphical format, a system or module can allow a user of the system to determine the status, strength, weakness and/or state of external contacts connected to one or more members of the organization, individually and/or in the aggregate.

FIGS. 6-13 illustrate user-interface screens associated with an implementation of a social network integration system, according to various embodiments.

FIG. 6 illustrates a user-interface screen showing a unified social network profile, according to an embodiment. More specifically, FIG. 6 illustrates a user-interface screen showing a percentage of social network profile completeness for a member of an organization. FIG. 6 also illustrates a series of rankings for the member of the organization. As shown in FIG. 6, the user-interface screen shows rankings for a number of connections, a number of connections in selected industries and a number of connections at selected levels within the connections' respective organizations. As also shown in FIG. 6, the user-interface screen shows a number of training courses completed by the user/member of the organization. Although shown as identifying a number of training courses, in other embodiments, the user-interface screen can include a parameter associated with any aspect of the user's social network profile (e.g., a number of certifications, a number of peer recommendations or the like).

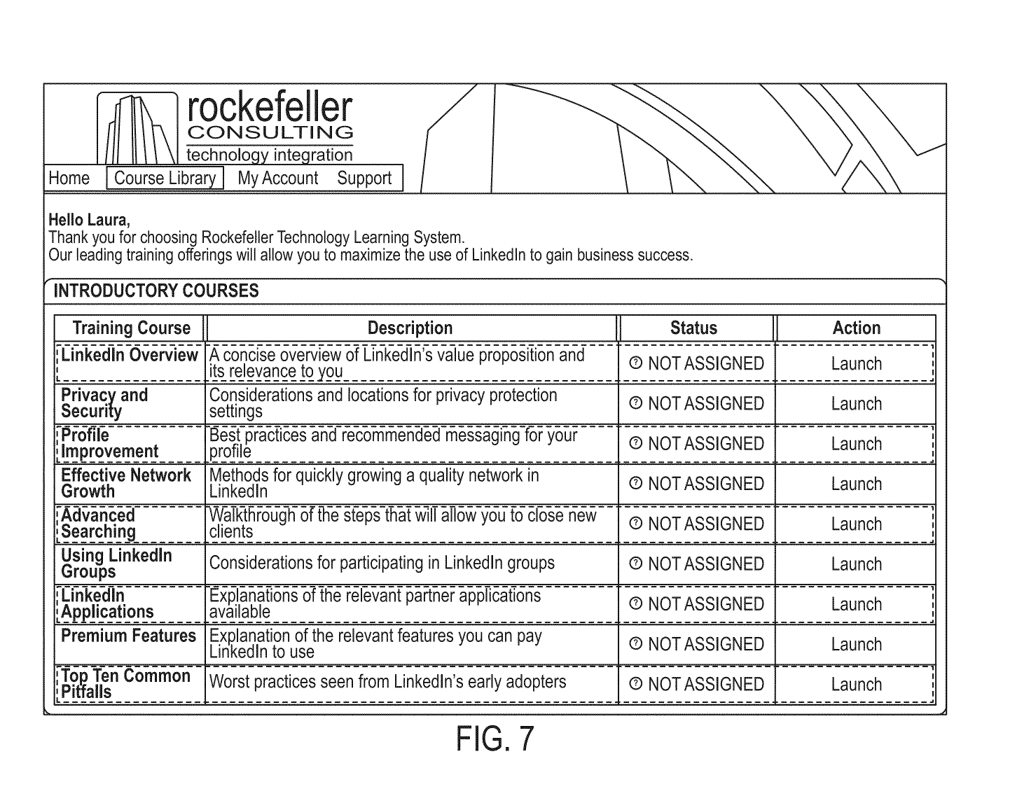

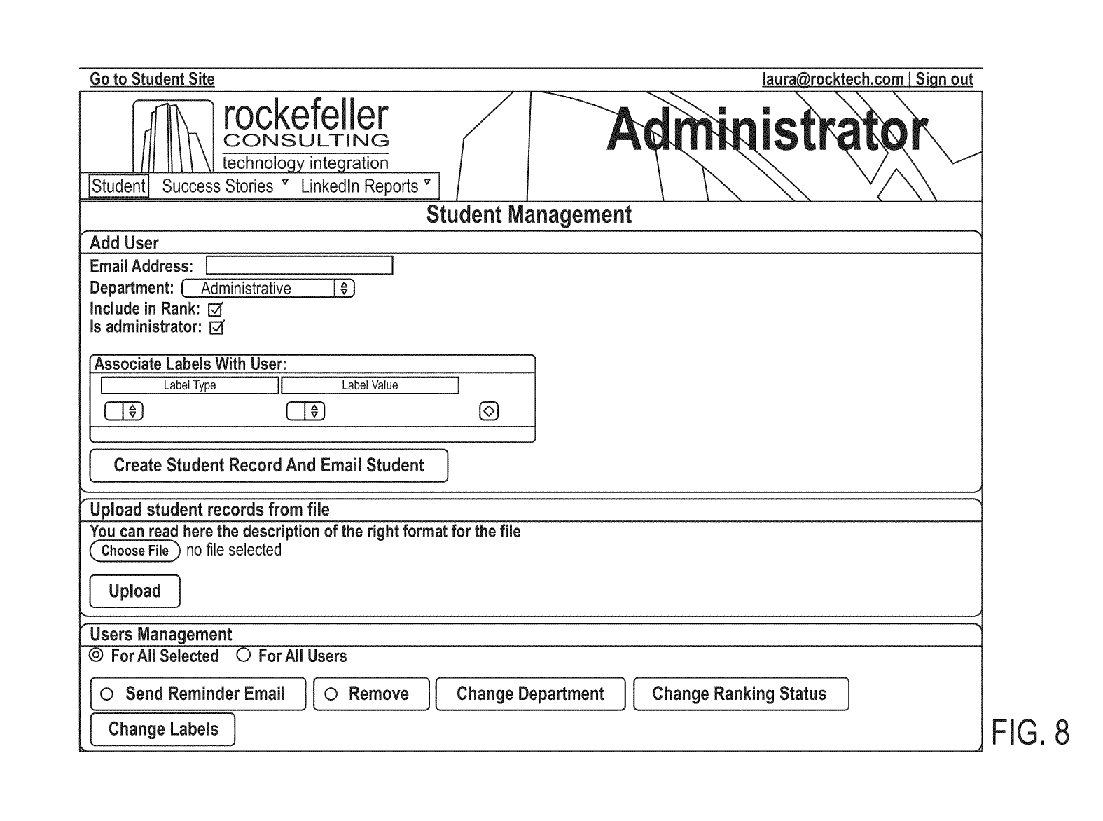

FIG. 7 illustrates a user-interface screen showing a welcome screen associated with a social network system training catalog, according to an embodiment. FIG. 8 illustrates a user-interface screen showing a student management screen associated with administration of a social network system training system, according to an embodiment.

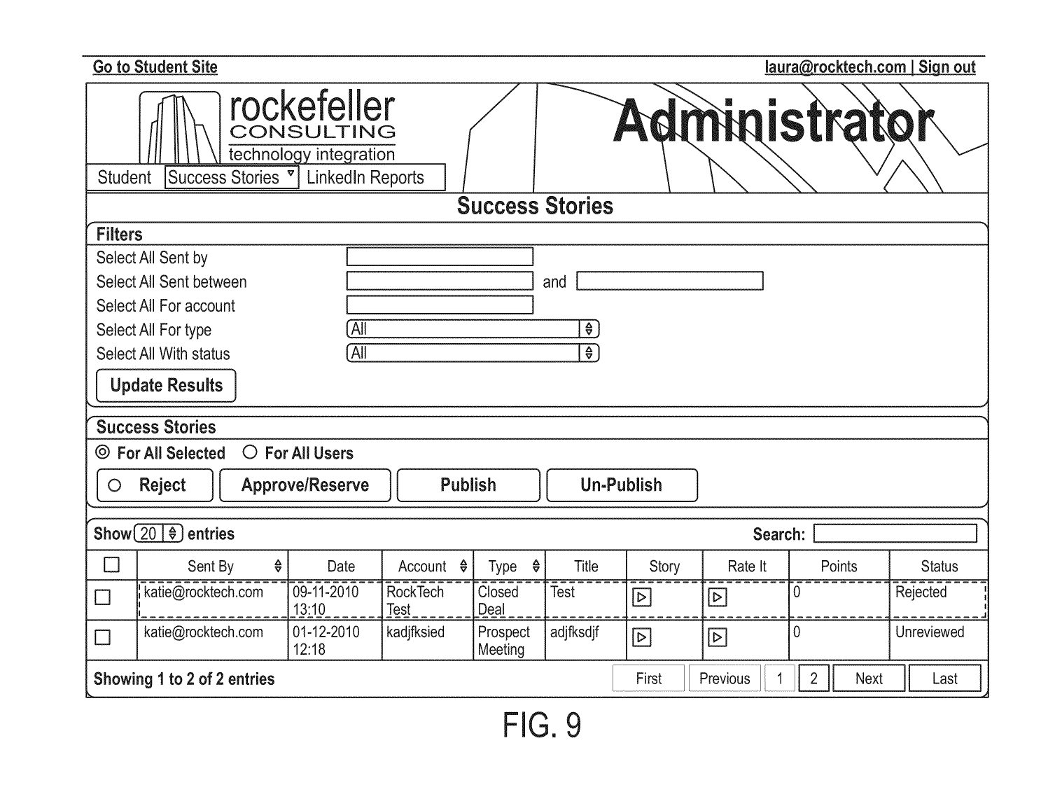

FIG. 9 illustrates a user-interface screen showing a success story search function, according to an embodiment. More specifically, the screen shows a user interface allowing a user to search for one or more success stories associated with one or more external organizations and/or companies. By use of the user-interface screen, a user of the system can access one or more text-based accounts based on successful interaction with a member of a given company or external organization.

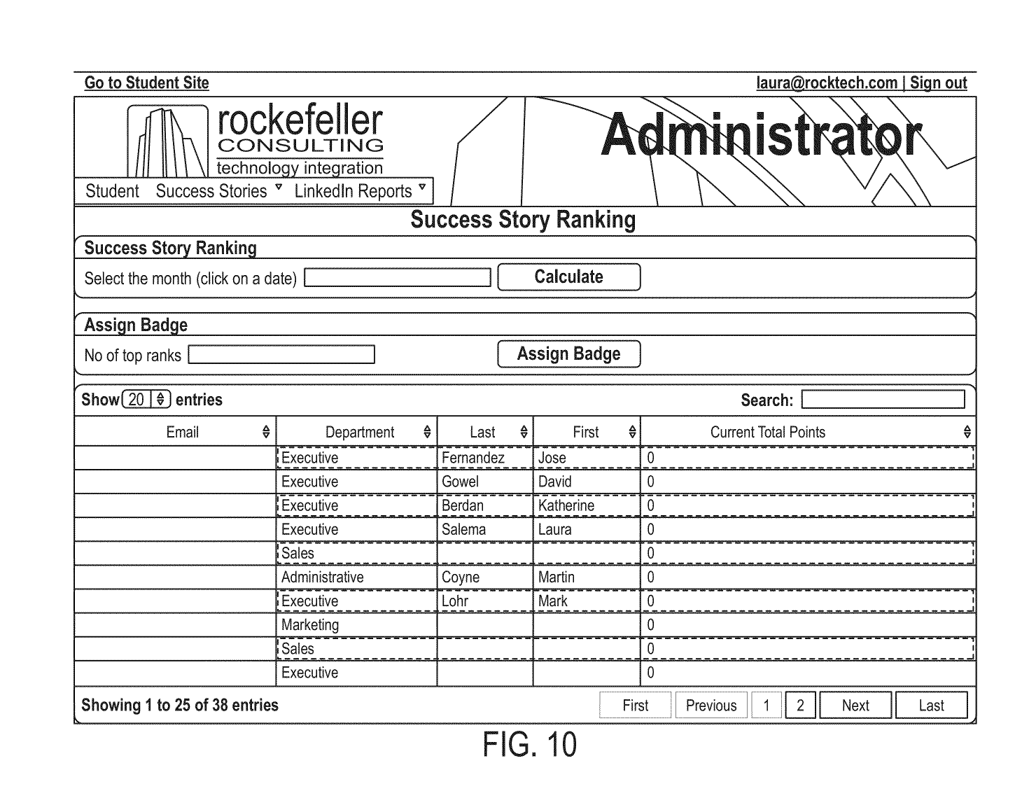

FIG. 10 illustrates a user-interface screen showing a ranking of organization members by a total number of success stories entered, according to an embodiment. More specifically, by use of the user-interface screen, an organization member or administrator can determine which members of the organization have entered the most and/or least success stories associated with external organizations and/or companies.

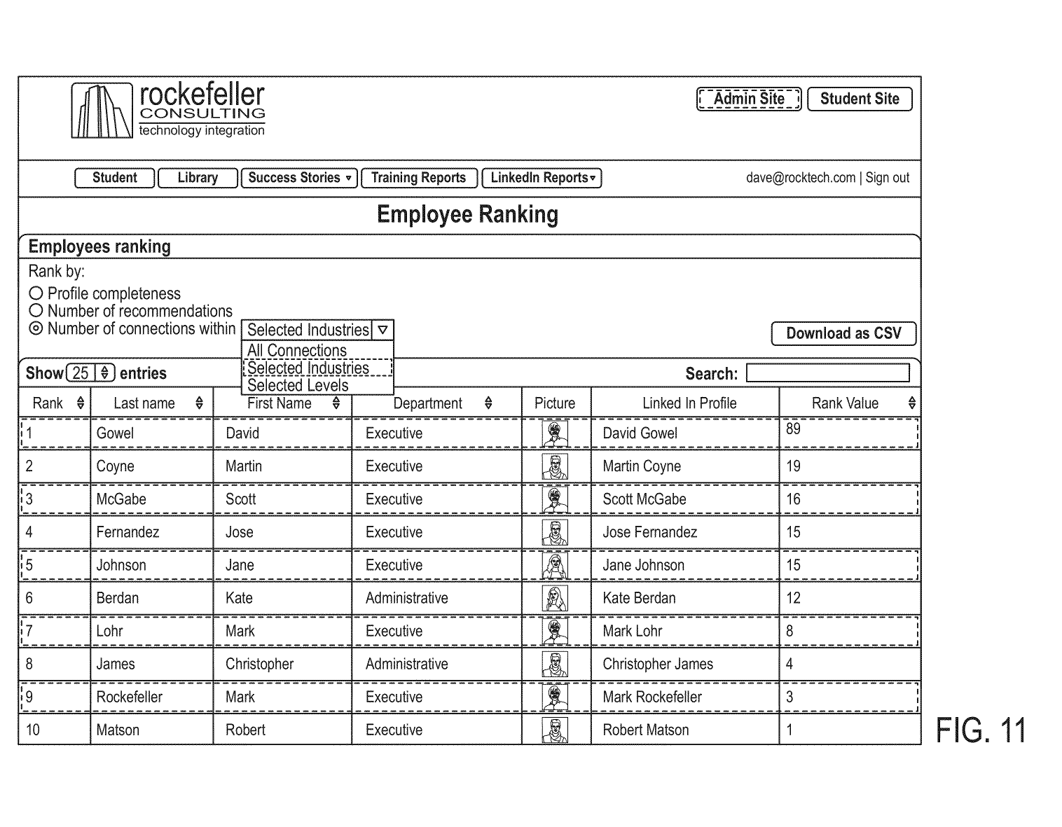

FIG. 11 illustrates a user-interface screen showing a ranking module, according to an embodiment. More specifically, by use of the user-interface screen, an organization member and/or administrator can determine which members of the organization have the highest percentage of social network system profile completion, the largest number of recommendations, and/or the largest number of connection—be it total, within a selected industry and/or at a specified hierarchical/managerial level.

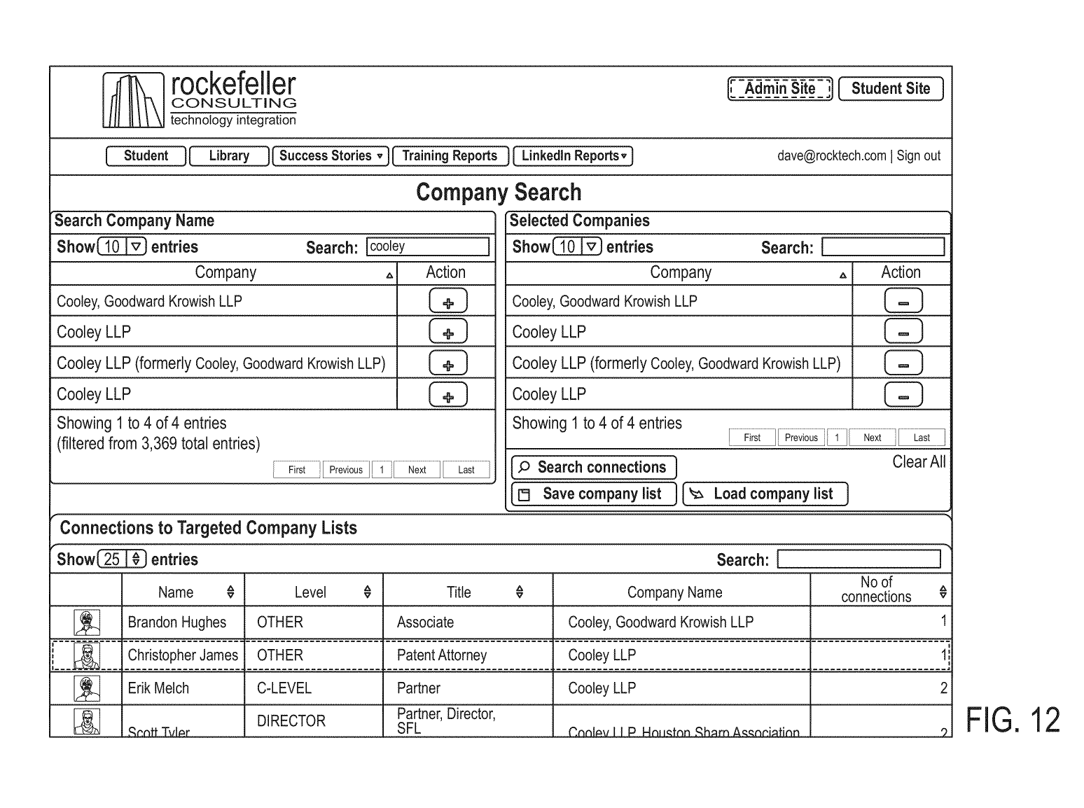

FIG. 12 illustrates a user-interface for a company search function, according to an embodiment. More specifically, FIG. 12 shows a search result list of employees of a searched-for company, along with a number of members of an organization whose social networks include one or more of the employees included in the search results.

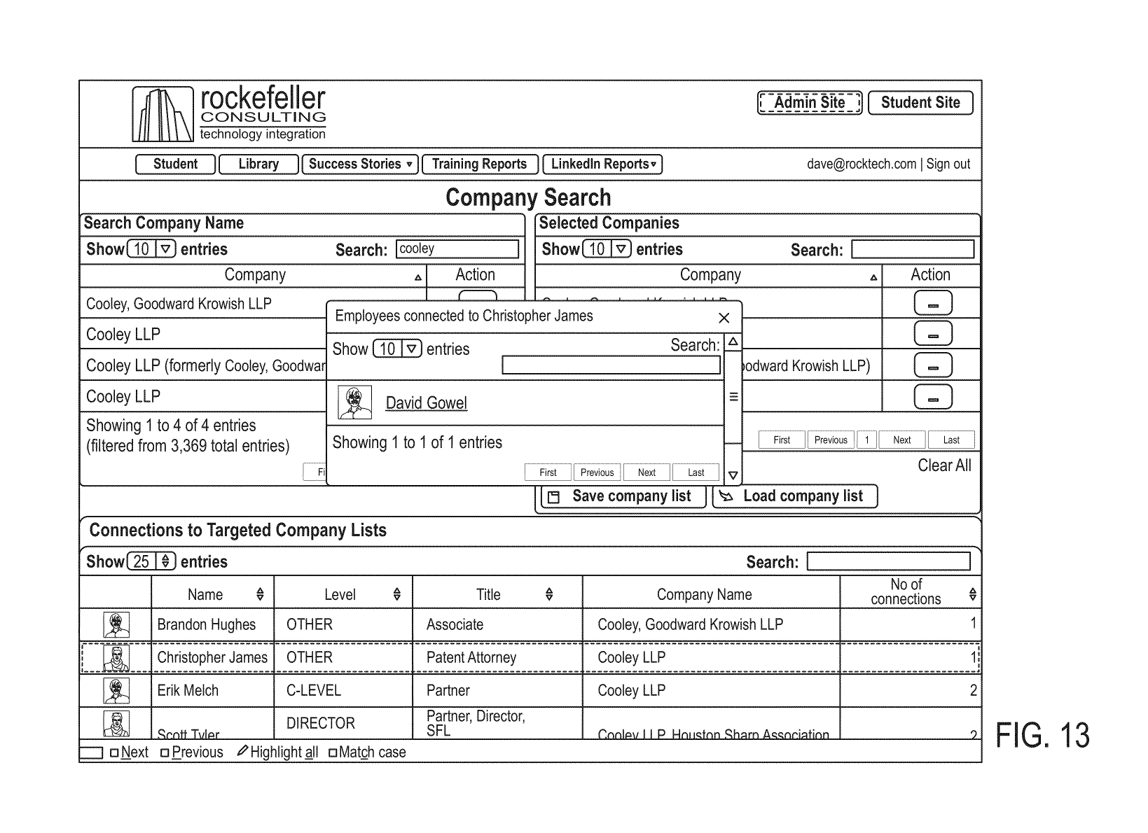

FIG. 13 illustrates a user-interface screen showing a set of search results of organization members connected to a selected employee within a selected company, according to an embodiment. More specifically, FIG. 13 illustrates a user-interface screen showing a single member of the organization connected, via a social network system, to a selected member of the queried company. By using such a screen, an organization member and/or administrator can determine which members of the organization are connected via a social network system to an employee of a selected company. Said differently, the screen allows a user of the unified social network information system to determine which members of the organization have, within his and/or her personal social network, one or more individuals employed at the selected company.

Some embodiments described herein relate to a computer storage product with a computer- or processor-readable medium having instructions or computer code thereon for performing various computer-implemented operations. The media and computer code (also can be referred to as code) may be those designed and constructed for the specific purpose or purposes. Examples of computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as general purpose microprocessors, microcontrollers, Application-Specific Integrated Circuits (ASICs), Programmable Logic Devices (PLDs), and Read-Only Memory (ROM) and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

While various embodiments have been described above, it should be understood that they have been presented by way of example only, and not limitation. Where methods and/or schematics described above indicate certain events and/or flow patterns occurring in certain order, the ordering of certain events and/or flow patterns may be modified. While the embodiments have been particularly shown and described, it will be understood that various changes in form and details may be made.

Although various embodiments have been described as having particular features and/or combinations of components, other embodiments are possible having a combination of any features and/or components from any of embodiments as discussed above. For example, in some embodiments, the organization server can be physically located at a location remote from the member device and/or administrator device. In another example, the organization server can be included and/or instantiated at a same physical or logical device as the administrator device.

1-14. (canceled)

15. A method of identifying a connection of interest within an online social networking system from connections of a plurality of users, wherein each of the plurality of users has a profile associated with the online social networking system, and wherein each of the plurality of users is a member of a first organization, the method comprising:
receiving a query specifying at least one criteria regarding the connection of interest;
automatically analyzing the connections of the plurality of users; and
identifying at least one of the plurality of users that has a connection via the online social networking system to the connection of interest.

16. The method of claim 15, wherein the query specifies a specific industry, organization and/or company, and wherein identifying the at least one of the plurality of users comprises identifying at least one of the plurality of users that has a connection via the social networking system to a connection of interest associated with the specific industry, organization and/or company.

17. The method of claim 16, wherein the query specifies a hierarchical position associated with the connection of interest, and wherein identifying the at least one of the plurality of users comprises identifying at least one of the plurality of users that has a connection via the social networking system to a connection of interest associated with the specific industry, organization and/or company that has at least the hierarchical position.

18. The method of claim 17, wherein the query specifies a C-level position.

19. The method of claim 15, wherein the first organization is a company at which each of the plurality of users are employed.

20. The method of claim 15, wherein the query specifies a particular individual, and wherein identifying at least one of the plurality of users comprises identifying at least one of the plurality of users that has a connection to the particular individual.

21. The method of claim 15, wherein identifying at least one of the plurality of users that has a connection via the social networking system to the connection of interest comprises identifying at least one of the plurality of users that has a direct connection and/or an indirect connection via the social networking system to the connection of interest.

22. A system for identifying a connection of interest within an online social networking system from connections of a plurality of users, wherein each of the plurality of users has a profile associated with the online social networking system, and wherein each of the plurality of users is a member of a first organization, the system comprising:
at least one computer communicatively coupled to at least a portion of the online social networking system, the at least one computer programmed to perform:
receiving a query specifying at least one criteria regarding the connection of interest;
analyzing the connections of the plurality of users; and
identifying at least one of the plurality of users that has a connection via the online social networking system to the connection of interest.

23. The system of claim 22, wherein the query specifies a specific industry, organization and/or company, and wherein the at least one computer is programmed to perform identifying at least one of the plurality of users that has a connection via the social networking system to a connection of interest associated with the specific industry, organization and/or company.

24. The system of claim 23, wherein the query specifies a hierarchical position associated with the connection of interest, and wherein identifying the at least one of the plurality of users comprises identifying at least one of the plurality of users that has a connection via the social networking system to a connection of interest associated with the specific industry, organization and/or company that has at least the hierarchical position.

25. The system of claim 24, wherein the query specifies a C-level position.

26. The system of claim 22, wherein the first organization is a company at which each of the plurality of users are employed.

27. The system of claim 22, wherein the query specifies a particular individual, and wherein identifying at least one of the plurality of users comprises identifying at least one of the plurality of users that has a connection to the particular individual.

28. The system of claim 22, wherein identifying at least one of the plurality of users that has a connection via the social networking system to the connection of interest comprises identifying at least one of the plurality of users that has a direct connection and/or an indirect connection via the social networking system to the connection of interest.

29. At least one non-transitory computer-readable medium having instruction encoded thereon that, when executed by at least one processor, performs a method of identifying a connection of interest within an online social networking system from connections of a plurality of users, wherein each of the plurality of users has a profile associated with the online social networking system, and wherein each of the plurality of users is a member of a first organization, the method comprising:
receiving a query specifying at least one criteria regarding the connection of interest;
automatically analyzing the connections of the plurality of users; and
identifying at least one of the plurality of users that has a connection via the online social networking system to the connection of interest.

30. The method of claim 29, wherein the query specifies a specific industry, organization and/or company, and wherein identifying the at least one of the plurality of users comprises identifying at least one of the plurality of users that has a connection via the social networking system to a connection of interest associated with the specific industry, organization and/or company.

31. The method of claim 30, wherein the query specifies a hierarchical position associated with the connection of interest, and wherein identifying the at least one of the plurality of users comprises identifying at least one of the plurality of users that has a connection via the social networking system to a connection of interest associated with the specific industry, organization and/or company that has at least the hierarchical position.

32. The method of claim 31, wherein the query specifies a C-level position.

33. The method of claim 29, wherein the first organization is a company at which each of the plurality of users are employed.

34. The method of claim 29, wherein the query specifies a particular individual, and wherein identifying at least one of the plurality of users comprises identifying at least one of the plurality of users that has a connection to the particular individual.
